(19) United States
(12) Patent Application Publication
(10) Pub. No.: US 2003/0205892 A1
(43) Pub. Date: Nov. 6, 2003

(54) Protective assembly for a trailer

(76) Inventor: Craig D. Andrews, North Muskegon, MI (US)

Correspondence Address: FACTOR & PARTNERS, PLC, 305 HOOVER BOULEVARD, SUITE 300, HOLLAND, MI, 49423, US

(21) Appl. No.: 10/136,608

(22) Filed: May 1, 2002

(51) Int. Cl. B60R 1/00

(52) U.S. Cl. 280/770

(57) ABSTRACT

A protective assembly to protect a portion of an outer body of a trailer having a fixture, comprising: (a) a cover positionable over an outer body of a trailer, the cover including a plurality of edges and a fixture accommodating assembly associable with a fixture of a trailer; and (b) a fastening assembly capable of securing the cover to an outer body of a trailer.

### BACKGROUND OF THE INVENTION

1. Field of the Invention

The present invention relates in general to a protective assembly for a trailer, and more particularly, to protective assemblies for trailers which are operatively configured to provide protection, identification, and/or decoration for trailers during use, transportation, and/or storage.

2. Background Art

Protective cover assemblies have been known in the art for years and have been the subject of numerous United States Patents, including: U.S. Pat. No. 6,027,156 entitled “VEHICLE SHIELD DEVICE”; U.S. Pat. No. 5,158,324 entitled “PROTECTIVE COVER FOR VEHICLES”; U.S. Pat. No. 4,936,599 entitled “PROTECTOR SHIELD FOR THE FRONT END OF A TOWED VEHICLE”; and U.S. Pat. No. 3,987,863 entitled “VEHICLE INSECT PROTECTION APPARATUS.”

U.S. Pat. No. 6,027,156 discloses a vehicle shield device provided for mounting onto a front of a vehicle. The vehicle shield device has a hood protector portion and a fender protector portion for protecting portions of the hood and the fender from contact with airflow. The vehicle shield further includes an airflow deflector portion extending from a back edge of the hood protector portion for deflecting airflow away from a windshield of the vehicle. The hood protector portion, the fender protector portion, and the airflow deflector portion cooperate to form a continuous airflow engaging surface extending across a portion of the front of a vehicle.

U.S. Pat. No. 5,158,324 discloses a protective cover for vehicles, wherein a flexible material having a magnetic base portion with a resilient top portion laminated thereto is cut in segments to conform to a portion of an exterior body surface of a vehicle. More than one segment is placed adjacent to each other in side by side relation to provide a protective cover for a vehicle. The vehicle may be any known type of vehicle, and the protective cover may be cut to cover any portion of the vehicle where protection is desired. Indicia may be disposed upon at least one segment of the protective cover, and the resilient top portion is preferably visually distinct from the magnetic base portion for ease of assembly. The segments are removably secured to the vehicle, and have a plurality of spaced grooves across the magnetic base portion of each segment so that moisture may pass beneath the flexible material.

U.S. Pat. No. 4,936,599 discloses a universal tow guard for mounting to the front of a towed vehicle. There are first and second planar plastic shield members having a lip around top, bottom, and outer edges thereof. Each has an upper mounting point adjacent the top outer edge and a lower mounting point adjacent the bottom outer edge. Each also has a plurality of horizontal support bracket holes adjacent the bottom edge, a plurality of horizontal strut hole vertical pairs adjacent the top edge, and a plurality of horizontal width adjustment hole vertical pairs adjacent an inner end thereof. The second shield member slidably fits within the lips of the first shield member. There are a pair of adjustable struts for connection between selected ones of the strut hole vertical pairs and a front surface of the vehicle. There are also a pair of support brackets for connection to selected ones of the support bracket holes and for resting on the vehicle bumper. Finally, there are a plurality of elastic strap members for connection between the vehicle and the upper and lower mounting points. Each strap member comprises a cord of an elastic material having a deformable material at one end, formed into a hook which matches contours of a point of attachment of the vehicle, wherein the opposite end is connected to one of the mounting points. There are protective sleeves of a soft, nonabrasive material for protecting the vehicle's surface which are disposed over the deformable material and the cord.

U.S. Pat. No. 3,987,863 discloses an insect protection apparatus for protecting moving vehicles having a rigid frame at least partially covered with a screen to prevent the passage of insects therethrough. The frame has a bumper attaching system which may be easily attached to most vehicle bumpers and which allows the frame to be rapidly attached and removed from the bumper attaching system. A deflector shield may also be attached to the front of the rigid frame, and the bumper attaching system may align the frame in front of the vehicle.

While the above-identified devices do appear to protect trailers and the like, their configurations remain non-desirous and/or problematic inasmuch as none of the above-identified devices are designed to provide protection, identification, and/or decoration for trailers during use, transportation, and/or storage.

It is therefore an object of the present invention to provide a protective cover assembly which, among other things, remedies the aforementioned detriments and/or complications associated with the use of conventional protective cover assemblies.

### SUMMARY OF THE INVENTION

The present invention is directed to a protective assembly to protect a portion of an outer body of a trailer having a fixture comprising: (a) a cover positionable over an outer body of a trailer, the cover including a plurality of edges and a fixture accommodating assembly associable with a fixture of a trailer; and (b) a fastening assembly capable of securing the cover to an outer body of a trailer.

In a preferred embodiment of the present invention, the fixture accommodating assembly comprises a plurality of perforations dividing portions of the cover into at least two sections, wherein the perforations are selectively frangible to facilitate removal of at least one section to, in turn, reveal at least one fixture.

In another preferred embodiment of the present invention, the fixture accommodating assembly comprises: (a) at least one opening extending through the cover, the at least one opening strategically positioned relative to the cover so as to correspond to a fixture; (b) at least one cover member positionably overlying the at least one opening and a surrounding portion of the cover; and (c) a fastener capable of securing the cover member to the cover. In this embodiment, preferably, the cover member is fabricated from a substantially transparent material, and, more preferably, the fastener capable of securing the cover member to the cover is selected from the group comprising stitching, snaps, buttons, ties, Velcro, magnets, twist fasteners, and any combination thereof.

In a further embodiment, it is preferred that the fixture accommodating assembly comprises: (a) at least one opening extending through the cover; and (b) a sizably variable securing assembly associated with the cover to, in turn, sizably vary the resulting dimensions of the at least one opening. In this embodiment, it is preferred that the sizably variable securing assembly comprises one of the group consisting of elastic, drawstrings, bellows, and any combination thereof.

In a preferred embodiment, the fastening assembly comprises: (a) a rod assembly having at least two rods and at least one fastener associated with each rod for securing each respective rod to an outer body of a trailer; and (b) means for associating at least two of the plurality of edges of the cover with the rod assembly.

Preferably, the associating means comprises a plurality of fasteners capable of securing desired edges of the cover to a respective rod of the at least two rods. More preferably, the associating means comprises a loop associated with each of two edges of the cover, wherein a separate rod of the at least two rods is capable of extending through a respective loop. Alternatively, it is preferred that the associating means comprise a slit extending through each of the at least two rods, each slit being capable of releasably retaining at least a portion of one of the plurality of edges of the cover therein.

The present invention is also directed to a protective assembly to protect a portion of an outer body of a trailer, comprising: (a) a cover positionable over an outer body of a trailer, the cover having a plurality of edges; (b) a rod assembly having at least two rods and at least one fastener associated with each rod for securing each respective rod to an outer body of a trailer; and (c) means for associating at least two of the plurality of edges of the cover with the rod assembly.

In a preferred embodiment of the present invention, each of the at least two rods has a first end portion and a second end portion at opposing ends thereof, each of the first end portion and the second end portion being securable to an outer body of a trailer via the at least one fastener. Preferably, the first and second end portions of the at least two rods are releasably associated with each respective rod.

In another preferred embodiment of the present invention, the associating means comprises a plurality of fasteners capable of securing desired edges of the cover to a respective rod of the at least two rods. Preferably, the associating means comprises a loop associated with each of the two edges of the cover, wherein a separate rod of the at least two rods is capable of extending through a respective loop. More preferably, the associating means comprises a slit extending through each of the at least two rods, each slit capable of releasably retaining at least a portion of one of the plurality of edges of the cover therein.

The present invention is also directed to a protective assembly to protect a portion of an outer body of a trailer comprising: (a) a housing assembly securable to the outside of a trailer; (b) at least one cover positionable within the housing assembly, the cover extendable from a retracted position wherein the cover is substantially within the housing assembly to a deployed position wherein the cover extends over an outer body of a trailer; and (c) at least one fastener capable of securing the at least one cover in a deployed position.

In a preferred embodiment of the present invention, the protective assembly comprises at least two covers, and the housing assembly comprises: (a) an outer retainer having a plurality of slots extending therethrough, wherein each of the plurality of slots is operably configured for slidable receipt and release of a portion of one of the covers therethrough; and (b) a divider positionable within the outer retainer, to, in turn, create at least two partitions within the outer retainer for separately retaining the at least two covers therein.

In another preferred embodiment, the outer retainer has a first end cap and a second end cap at opposing ends thereof and securable to an outer body of a trailer via the assembly for securing the housing assembly to a trailer. Preferably, the first and second end caps of the outer retainer are releasably secured to the outer retainer.

### BRIEF DESCRIPTION OF THE DRAWINGS:

The invention will now be described with reference to the drawings wherein:

FIG. 1 of the drawings is a front elevational view of a protective assembly in accordance with the present invention, showing, among other things a first embodiment of a fixture accommodating assembly associable with a fixture of a trailer;

FIG. 2 of the drawings is a cross-sectional view of a cover of the protective assembly of FIG. 1, taken generally about line 2-2 of FIG. 1;

FIG. 3 of the drawings is a front elevational view of a cover of a protective assembly in accordance with the present invention, showing, among other things, a second embodiment of a fixture accommodating assembly associable with a fixture of a trailer;

FIG. 4 of the drawings is a front elevational view of a protective assembly in accordance with the present invention, showing, among other things, a third embodiment of a fixture accommodating assembly associable with a fixture of a trailer comprising, among other things, a cover member;

FIG. 5 of the drawings is a front elevational view of a protective assembly in accordance with the present invention, showing, among other things, a fourth embodiment of a fixture accommodating assembly associable with a fixture of a trailer comprising, among other things, a cover member and a secondary opening;

FIG. 6 of the drawings is a front elevational view of a protective assembly in accordance with the present invention, showing, among other things, an embodiment of a rod assembly for securing a cover to a trailer comprising, among other things, a plurality of fasteners;

FIG. 7 of the drawings is a perspective view of an embodiment of a rod assembly for securing a cover to a trailer comprising, among other things, a first embodiment of a means for associating desired edges of the cover to the rod assembly in accordance with the present invention;

FIG. 8 of the drawings is a perspective view of an embodiment of a rod assembly for securing a cover to a trailer comprising, among other things, a second embodiment of a means for associating desired edges of the cover to the rod assembly in accordance with the present invention;

FIG. 9 of the drawings is a front elevational view of a second embodiment of a protective assembly in accordance with the present invention, showing, among other things, a housing assembly comprising an outer retainer;

FIG. 10 of the drawings is a cross-sectional view of the outer retainer of FIG. 9, taken generally about line 4-4 of FIG. 9, showing, among other things, a plurality of covers therein; and

FIG. 11 of the drawings is a cross-sectional view of an outer retainer in accordance with the present invention, showing, among other things, a cover therein.

### DETAILED DESCRIPTION OF THE INVENTION:

While this invention is capable of embodiment in many different forms, there is shown in the drawings and described herein in detail several specific embodiments with the understanding that the present disclosure is to be considered as an exemplification of the principles of the invention and is not intended to limit the invention to the embodiments illustrated.

It will be understood that like or analogous elements and/or components, referred to herein, may be identified throughout the drawings with like reference characters. In addition, it will be understood that the drawings are merely representations, and some of the components may have been distorted from actual scale for purposes of pictorial clarity.

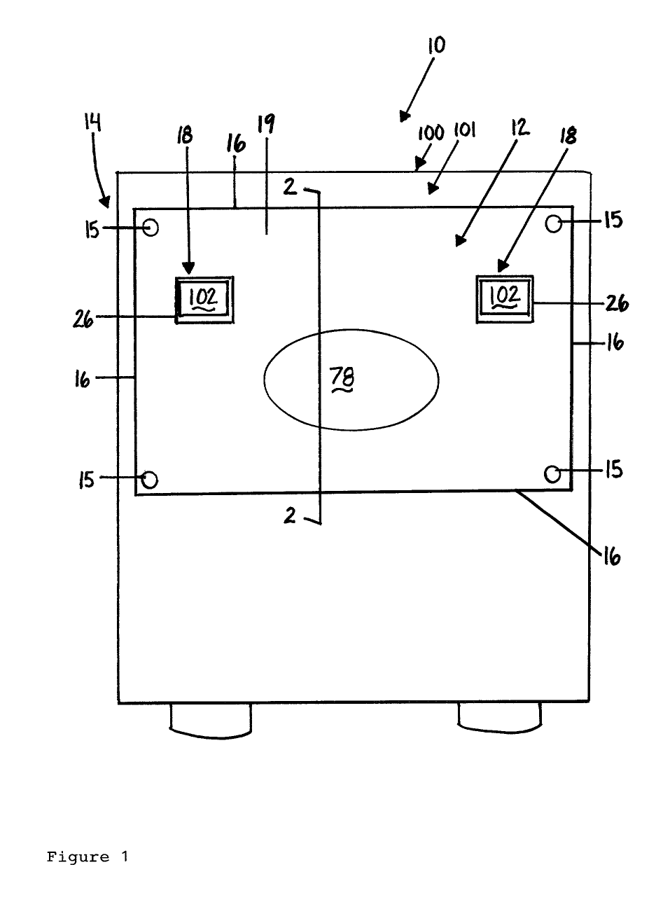

Referring now to the drawings, and to FIG. 1 in particular, protective assembly 10 to protect a portion of a trailer, such as trailer 100, is shown as generally comprising cover 12 and fastening assembly 14.

It will be understood that protective assembly 10 can be used in association with any one of a number of trailer applications, such as, for example, travel trailers, fifth wheels, motor homes, and/or other recreational vehicles. However, its use is not limited to any particular type of trailer, and, therefore, trailer 100 will herein be understood to comprise any type of recreational vehicle for which it is desirable to protect a portion thereof. Furthermore, trailer 100 is shown as comprising outer body 101 and a fixture, such as fixture 102. Outer body 101 may comprise fiberglass or metal paneling which may be smooth or corrugated. Generally, such material is water impervious. Fixture 102 may be any one of a number of different fixtures, such as, for example, a reflector or a light. However, the use of protective assembly 10 is not limited to any particular type of fixture or position or number thereof.

Cover 12 is shown in FIG. 1 as generally comprising web 19 having a plurality of edges 16 and fixture accommodating assembly 18 associable with fixture 102. Cover 12 is positionable over outer body 101 of trailer 100 to substantially protect the body of the trailer from dirt, bugs, and/or other debris during use, transport, and/or storage. Although cover 12 is shown in FIG. 1 as substantially rectangular, the particular shape of cover 12 is not crucial, and a variety of shapes are contemplated for use.

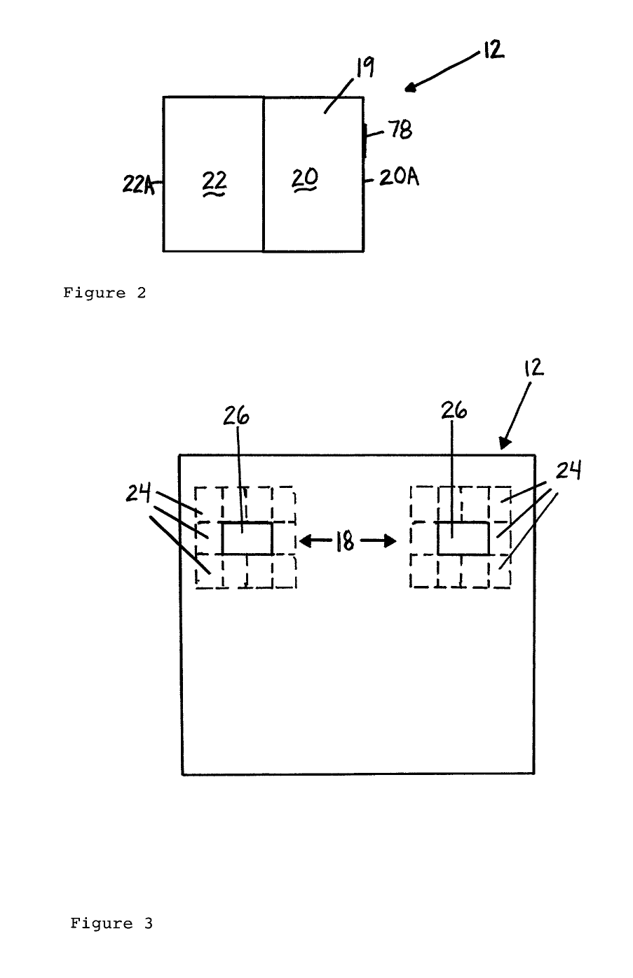

Referring now to FIG. 2, web 19 of cover 12 includes outer layer 20 having airflow engaging surface 20A and inner layer 22 having body engaging surface 22A. Outer layer 20 preferably comprises a substantially weatherproof material, such as, but not limited to, nylon and/or vinyl, and inner layer 22 preferably comprises a substantially non-abrasive material, such as, but not limited to, cotton, felt, and/or polyester. However, it will be understood that outer and inner layers 20, 22 may comprise a variety of natural and/or synthetic materials. In such an embodiment, the two layers may be adhered or stitched together. Outer layer 20 may further comprise indicia 78 such as a decorative design and/or text applied via silk screen processes, embroidery, etcetera.

Fixture accommodating assembly 18 is shown in FIG. 1 as generally comprising an opening such as opening 26 extending through cover 12 proximate each fixture 102. While fixture accommodating assembly 18 is shown in FIG. 1 as including two openings 26, any number of openings 26 are contemplated for use, depending on the number of fixtures 102. For ease of description, a single opening 26 will be described herein with the understanding that any number of openings 26 are contemplated. Opening 26 may comprise any one of a number of different shapes and sizes, however, preferably, opening 26 comprises a size and shape larger than fixture 102 over which it is positioned. Likewise, the positioning of opening 26 is preferably such that when cover 12 is placed over an outer body of trailer 100, opening 26 is positioned at least over fixture 102.

In a second embodiment, fixture accommodating assembly 18 is shown in FIG. 3 as comprising a plurality of perforations 24 dividing portions of cover 12 into at least two sections, wherein at least one of the sections may be strategically removed, such that opening 26 can be positioned over fixture 102. While FIG. 3 shows the removal of two perforated sections to reveal fixture 102 therebeneath, fixture accommodating assembly 18 enables protective assembly 10 to be adaptable for use on any one of a number of different trailers having varying numbers of and positioning of variously sized fixtures inasmuch as any one or more of perforated sections are removable, depending on the location and size of fixture 102 therebeneath.

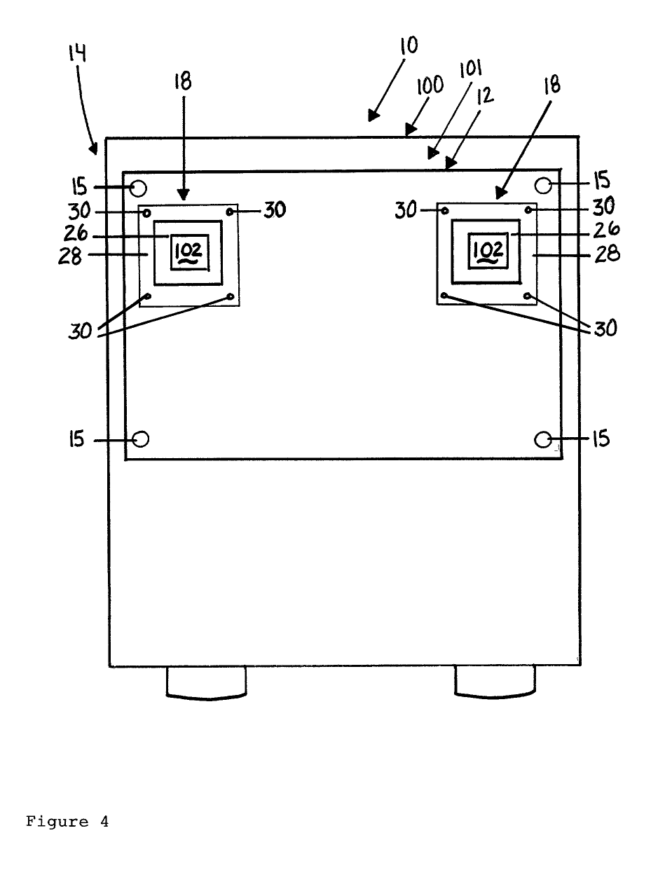

In a third embodiment, fixture accommodating assembly 18 is shown in FIG. 4 as further comprising cover member 28 and a plurality of fasteners 30 capable of securing cover member 28 to a portion of cover 12, to, in turn, facilitate the positioning of cover member 28 over at least one opening 26 and fixture 102. Preferably, cover member 28 is fabricated from a substantially transparent material and comprises any size and shape larger than opening 26. Fasteners 30 may comprise any one of a number of fasteners capable of securing cover member 28 to a portion of cover 12, such as, for example, stitching, snaps, buttons, ties, Velcro, etcetera.

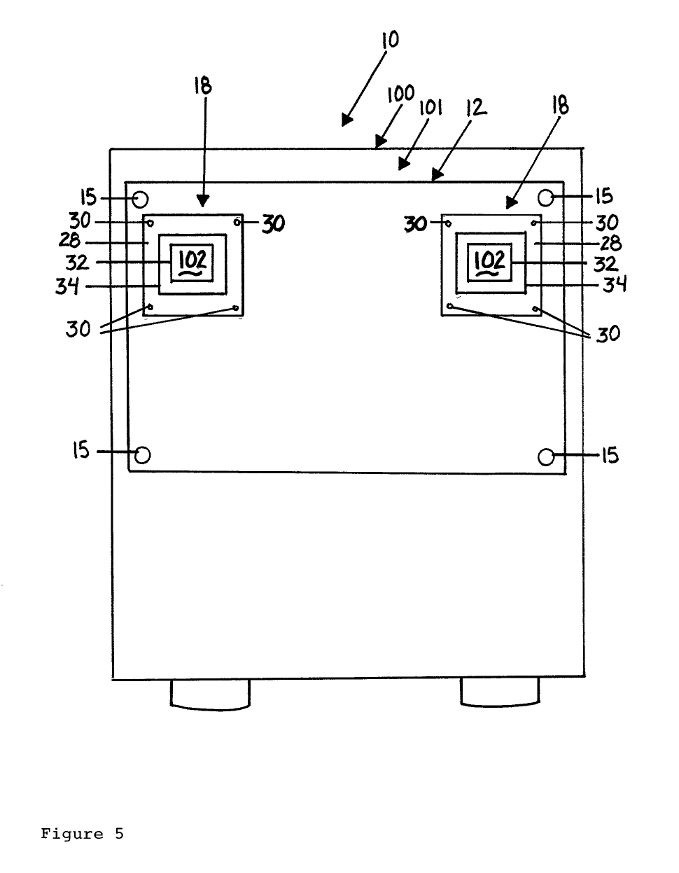

In a fourth embodiment of fixture accommodating assembly 18, cover member 28 is shown in FIG. 5 as comprising secondary opening 32 extending therethrough and assembly 34 for securing secondary opening 32 around fixture 102. Fasteners 30 are capable of securing cover member 28 to a portion of cover 12, to, in turn, facilitate the positioning of secondary opening 32 over fixture 102. In this embodiment, cover member 28 may comprise a material or materials substantially similar to cover 12. Assembly 18 enables protective assembly 10 to be adaptable for use on any one of a number of different trailers inasmuch as cover member 28 is securable to any portion of cover 12 which surrounds opening 26, in order to align secondary opening 32 with fixture 102. Secondary opening 32 may comprise any one of a number of different shapes and sizes, however, preferably, secondary opening 32 comprises a size and shape conducive to fitting around fixture 102. Assembly 34 for securing secondary opening 32 over fixture 102 comprises a sizably variable securing assembly such as, but not limited to, elastic, drawstrings, bellows, and/or any combination thereof.

Referring again to FIG. 1, fastening assembly 14 is shown as generally comprising four fasteners 15 such as, but not limited to, snaps, buttons, ties, Velcro, magnets, twist fasteners, and/or any combination thereof. However, it will be understood that any one of a number of fastening assemblies capable of securing cover 12 to outer body 101 of trailer 100 are contemplated for use. While four fasteners 15 are shown in FIG. 1, any number of fasteners 15 may be employed, in any number of different positions.

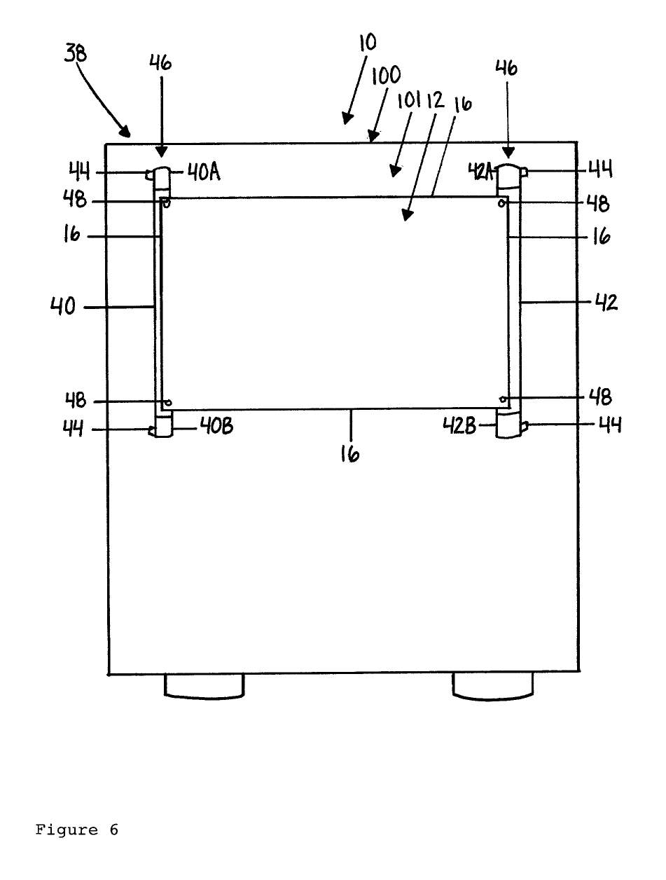

Alternatively, fastening assembly 14 is shown in FIG. 6 as comprising rod assembly 38, having at least two rods 40, 42 and at least one fastener 44 for securing each rod to an outer body of trailer 100, and means 46 for associating at least two of the plurality of edges 16 of cover 12 with rod assembly 38. It will be understood that although FIGS. 6-8 are shown as not including fixture accommodating assembly 18, embodiments are contemplated both with and without such assembly 18.

Rods 40 and 42 are each shown in FIG. 6 as generally comprising first end portion 40A, 42A, respectively, and second end portion 40B, 42B, respectively, at opposing ends thereof, wherein such end portions are securable to an outer body of trailer 100 via fasteners 44. Preferably, first and second end portions 40A, 42A, 40B, and 42B are detachable from their respective rods 40, 42. At least two rods 40, 42 may be fabricated from metal, alloys, composites, natural or synthetic resins, or any combination thereof. A variety of sizes and shapes of at least two rods 40 and 42 are contemplated for use as long as at least two edges 16 of cover 12 are associable therewith. Furthermore, while rods 40, 42 are shown in FIG. 6 as substantially vertically oriented, a wide variety of orientations are contemplated, such as horizontal and/or diagonal.

Fasteners 44 are shown in FIG. 6 as generally comprising four fasteners, such as, for example, bolts, screws, welding, etcetera. However, it will be understood that any one of a number of fastening agents capable of securing each rod to outer body 101 of trailer 100 is contemplated. Fasteners 44 may or may not releasably secure each rod to outer body 101.

Means 46 for associating at least two of the plurality of edges 16 of cover 12 with rod assembly 38 is shown in FIG. 6 as comprising fasteners 48, such as, but not limited to, snaps, buttons, ties, Velcro, magnets, twist fasteners, and/or any combination thereof. However, it will be understood that any one of a number of fastening agents capable of securing edges 16 to rods 40 and 42 is contemplated for use. While only four fasteners 48 are shown in FIG. 6, it will be understood that any number of fasteners 48 may be employed, in any variety of positions.

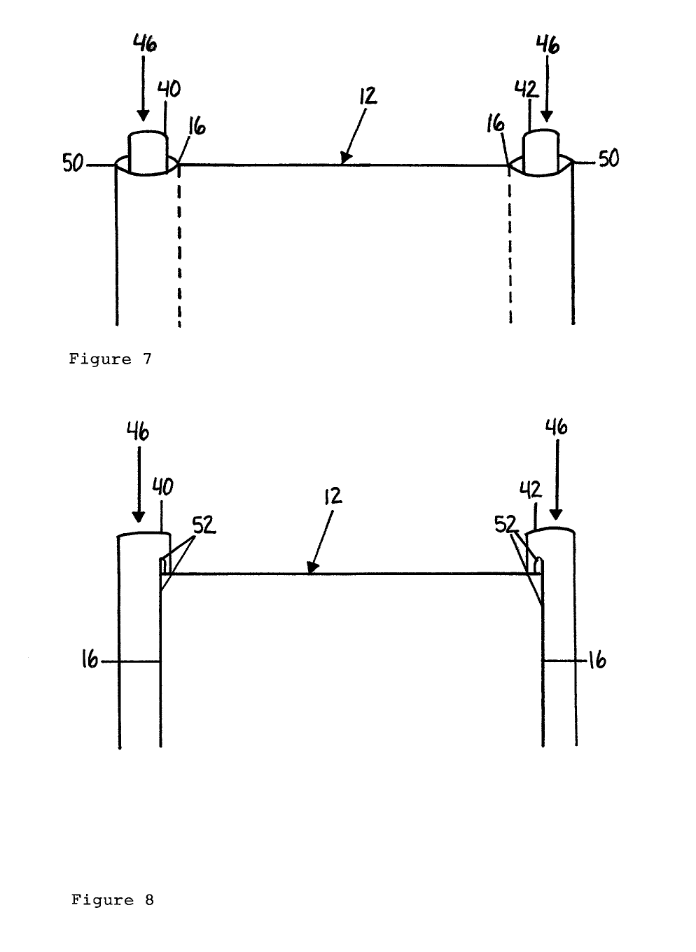

Alternatively, associating means 46 is shown in FIG. 7 as comprising loop 50 associated with each of at least two of the plurality of edges 16 of cover 12, wherein a separate rod, such as each of rods 40, 42, is capable of extending through a respective loop. Loops 50 may be fabricated by stitching edge 16 of cover 12 back to cover 12, for example.

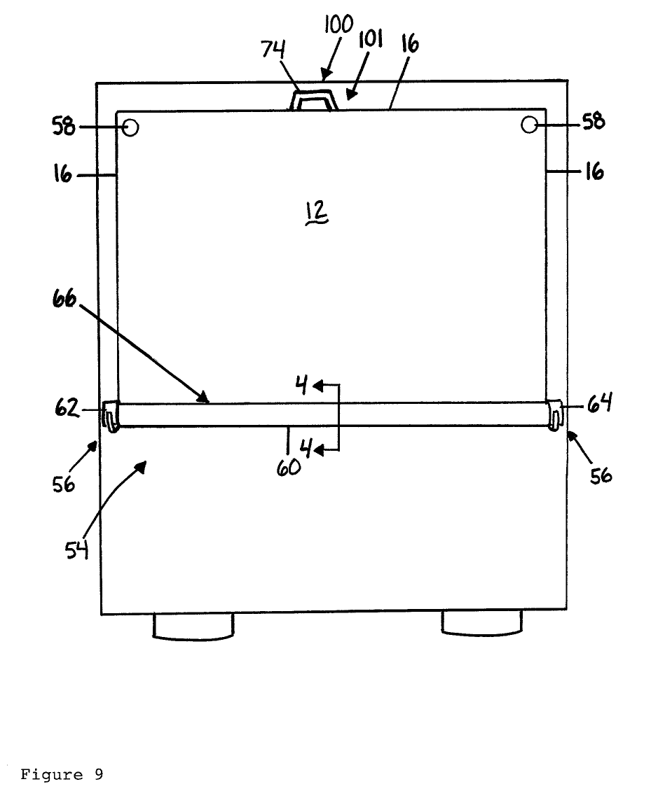

Alternatively, associating means 46 is shown in FIG. 8 as comprising slit 52 extending through each of the at least two rods 40, 42, each slit being capable of releasably retaining at least a portion of one of the plurality of edges 16 of cover 12 therein. Cover 12 may then be slid in and out of retention within slits 52 of rods 40, 42.

Protective assembly 10 may be assembled for use in association with trailer 100 having, for example, outer body 101 and fixture 102, by providing a user with cover 12 and fastening assembly 14. The user first secures cover 12 to trailer 100 via fastening assembly 14. Depending on the embodiment of fastening assembly 14, the user may either snap, button, tie, Velcro, magnetize, or twistably fasten cover 12 directly to trailer 100, or, alternatively, the user may secure cover 12 to trailer 100 via rod assembly 38. During employment of rod assembly 38, preferably, end portions 40A, 40B, 42A, and 42B are first secured to trailer 100 via fasteners 44. Rods 40, 42 may then be associated with cover 12 by slipping rods 40, 42 within loops 50 or fitting edge 16 of cover 12 into slit 52 of the rods. Rods 40, 42 are then attached to their respective end portions, thereby securing rods 40, 42 to trailer 100 and, in turn, securing cover 12 to the rods. Alternatively, rods 40, 42 may be secured directly to trailer 100 via fasteners 44 and the user may snap, button, tie, Velcro, magnetize, or twistably fasten cover 12 directly to at least two rods 40, 42.

Once cover 12 is secured to trailer 100, assembly 18 may be employed. Depending on the embodiment of assembly 18 provided, the user may reveal fixture 102 through opening 26 of cover 12 by removing perforated sections 24, securing transparent cover member 28 over opening 26, or securing cover member 28 to a portion of cover 12 such that secondary opening 32 is over opening 26 of cover 12, and, subsequently, securing assembly 34 around fixture 102 by tying, elastically fitting, or fastening bellows therearound.

An additional embodiment of protective assembly 10 is shown in FIG. 9 as comprising at least one cover 12 having plurality of edges 16, housing assembly 54, assembly 56 for securing housing assembly 54 to trailer 100, and at least one fastener 58 for securing at least one of plurality of edges 16 to outer body 101 of trailer 100.

Although not shown in FIG. 9, it is contemplated that at least one cover 12 includes any or all of the elements described herein associated with cover 12 in the preceding figures, such as, but not limited to, fixture accommodating assembly 18 and rod assembly 38.

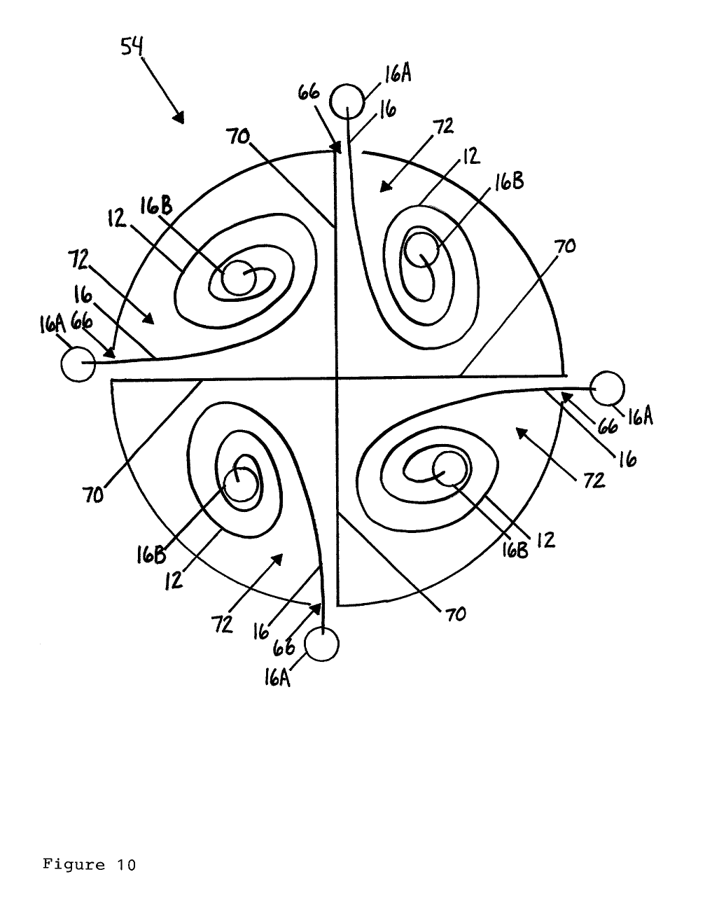

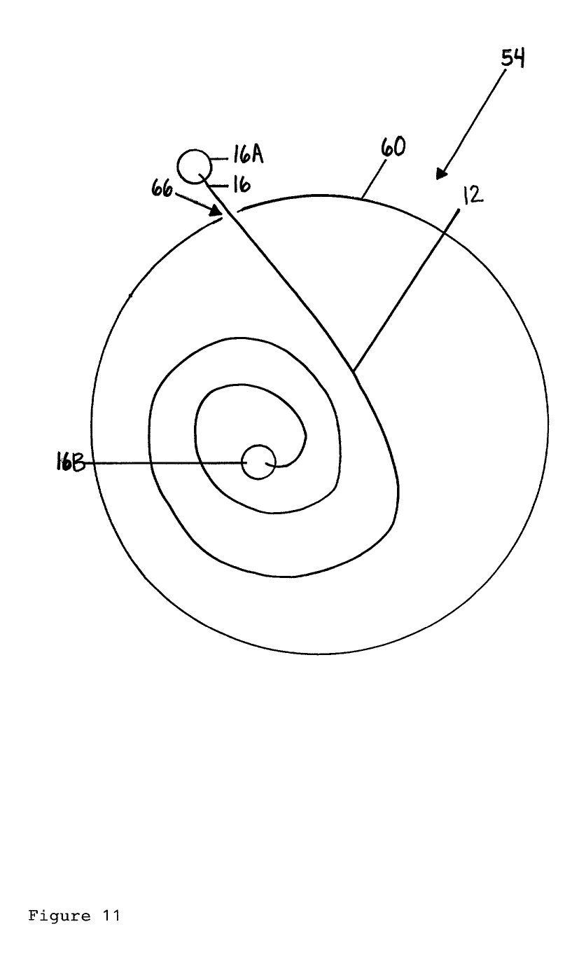

Housing assembly 54 is shown in a cross-sectional view in FIG. 10 as generally comprising outer retainer 60 and divider 68. Housing assembly 54 is operably configured to house at least one cover 12 therein and to release a portion of at least one cover 12 upon application of an external force, such as a user pulling such cover 12 out therefrom. As is shown in FIG. 11, in the case of housing assembly 54 only housing one cover 12, divider 68 is not necessary.

Outer retainer 60 is shown collectively in FIGS. 9-11 as generally comprising at least one slot 66 extending therethrough, wherein each of slots 66 is operably configured for slidable receipt and release of one of covers 12 therethrough. In this embodiment, cover 12 may comprise first and second ridged edges 16A and 16B wherein such ridged edges are configured such that they do not fit through slots 66. In this way, when cover 12 is inserted into outer retainer 60, ridged edge 16A remains outside of outer retainer 60 while ridged edge 16B remains within outer retainer 60. The portion of cover 12 between ridges edges 16A and 16B may then be slid in and out of outer retainer 60, through slot 66.

Outer retainer 60 may further comprise first end cap 62 and second end cap 64 at opposing ends thereof, which are securable to outer body 101 of trailer 100 via assembly 56 for securing housing assembly 54 to trailer 100. Preferably, first and second end caps 62, 64 are detachable from outer retainer 60. Alternatively, it is contemplated that end caps are not included, and assembly 56 is attached directly to outer retainer 60.

While outer retainer 60 is shown as substantially oblong, the shape of outer retainer 60 is not crucial, and a variety of shapes are contemplated for use. Likewise, while outer retainer 60 is shown as being positioned below cover 12, when deployed, the position of outer retainer 60 is not crucial, and it is contemplated that outer retainer 60 is positioned proximate a lower, middle, or upper portion of outer body 101 such that cover 12 may be extended above or below therefrom. Outer retainer 60 may be fabricated from wood, metals, alloys, composites, natural and/or synthetic resins, or any combination thereof.

Divider 68 is shown in FIG. 10 as comprising a plurality of arms 70. Divider 68 is positionable within outer retainer 60, to, in turn, create at least two partitions 72 within outer retainer 60 for separately retaining covers 12 within. While FIG. 10 shows divider 68 as comprising four arms 70, and, likewise, four partitions 72, it will be understood that divider 68 may comprise any number of arms 70 in order to obtain the desired number of partitions 72.

Assembly 56 for securing housing assembly 54 to trailer 100 is shown in FIG. 9 as comprising a plurality of clasps and fasteners, although any securing assembly known to those having ordinary skill in the art capable of securing housing assembly 54 to trailer 100 is likewise contemplated for use, and the invention is not limited to a particular securing assembly.

At least one fastener 58 is shown in FIG. 9 as generally comprising two fasteners 58 such as, but not limited to, hooks, snaps, buttons, ties, Velcro, magnets, twist fasteners, and/or any combination thereof. However, it will be understood that any one of a number of fastening agents capable of securing at least one of plurality of edges 16 of at least one cover 12 to an outer body of trailer 100 is contemplated for use. While two fasteners 58 are shown in FIG. 9 at opposing ends of cover 12, it will be understood that any number of fasteners 58 may be employed, in a variety of positions. Additionally, fastener 58 may be analogous to fastening assembly 14 described herein.

Additionally, handle 74 may be associated with one of edges 16 of cover 12 to aid a user in pulling cover 12 from housing assembly 54.

To assemble such a second embodiment of protective assembly 10, a user is provided with at least one cover 12, housing assembly 54, assembly 56, and at least one fastener 58. The user places a portion of at least one cover 12 within outer retainer 60 while a portion of cover 12 is within slot 66 and ridged edge 16A remains outside outer retainer 60. Preferably, cover 12 my be rolled within outer retainer 60, and, preferably, cover 12 may be slipped within outer retainer 60 when end cap 62 or 64 is detached. End caps 62, 64 may then be secured to their respective ends of outer retainer 60. Housing assembly 54 is then secured to trailer 100 via assembly 56.

In operation, one of at least one cover 12 may be pulled from outer retainer 54, through slot 66, and ridged edge 16A and/or another desired edge 16 may be secured to trailer 100 via at least one fastener 58. Alternatively, handle 74 may be secured to trailer 100 via fastener 58 comprising, for example, a hook. Once assembled, trailer 100 having protective assembly 10 thereon may be used, transported, and/or stored, thereby employing protective assembly 10 to protect an outer body of the trailer from dirt, bugs, and/or other debris while lending an attractive appearance to the trailer.

The foregoing description merely explains and illustrates the invention and the invention is not limited thereto except insofar as the appended claims are so limited, as those skilled in the art who have the disclosure before them will be able to make modifications without departing from the scope of the invention.

What is claimed is:

1. A protective assembly to protect a portion of an outer body of a trailer having a fixture, comprising:
a cover positionable over an outer body of a trailer, the cover including a plurality of edges and a fixture accommodating assembly associable with a fixture of a trailer; and
a fastening assembly capable of securing the cover to an outer body of a trailer.

2. The protective assembly according to claim 1, wherein the fixture accommodating assembly comprises:
a plurality of perforations dividing portions of the cover into at least two sections, wherein the perforations are selectively frangible to facilitate removal of at least one section to, in turn, reveal at least one fixture.

3. The protective assembly according to claim 1, wherein the fixture accommodating assembly comprises:
at least one opening extending through the cover, the at least one opening strategically positioned relative to the cover so as to correspond to a fixture;
at least one cover member positionably overlying the at least one opening and a surrounding portion of the cover; and
a fastener capable of securing the cover member to the cover.

4. The protective assembly according to claim 3, wherein the cover member is fabricated from a substantially transparent material.

5. The protective assembly according to claim 3, wherein the fastener capable of securing the cover member to the cover is selected from the group comprising stitching, snaps, buttons, ties, Velcro, magnets, twist fasteners, and any combination thereof.

6. The protective assembly according to claim 1, wherein the fixture accommodating assembly comprises:
at least one opening extending through the cover; and
a sizably variable securing assembly associated with the cover to, in turn, sizably vary the resulting dimensions of the at least one opening.

7. The protective assembly according to claim 6, wherein the sizably variable securing assembly comprises one of the group consisting of elastic, drawstrings, bellows, and any combination thereof.

8. The protective assembly according to claim 1, wherein the fastening assembly comprises:
a rod assembly having at least two rods and at least one fastener associated with each rod for securing each respective rod to an outer body of a trailer; and
means for associating at least two of the plurality of edges of the cover with the rod assembly.

9. The protective assembly according to claim 8, wherein the associating means comprises a plurality of fasteners capable of securing desired edges of the cover to a respective rod of the at least two rods.

10. The protective assembly according to claim 8, wherein the associating means comprises a loop associated with each of two edges of the cover, wherein a separate rod of the at least two rods is capable of extending through a respective loop.

11. The protective assembly according to claim 8, wherein the associating means comprises a slit extending through each of the at least two rods, each slit being capable of releasably retaining at least a portion of one of the plurality of edges of the cover therein.

12. A protective assembly to protect a portion of an outer body of a trailer, comprising:
a cover positionable over an outer body of a trailer, the cover having a plurality of edges;
a rod assembly having at least two rods and at least one fastener associated with each rod for securing each respective rod to an outer body of a trailer; and
means for associating at least two of the plurality of edges of the cover with the rod assembly.

13. The protective assembly according to claim 12, wherein each of the at least two rods has a first end portion and a second end portion at opposing ends thereof, each of the first end portion and the second end portion being securable to an outer body of a trailer via the at least one fastener.

14. The protective assembly according to claim 13, wherein the first and second end portions of the at least two rods are releasably associated with each respective rod.

15. The protective assembly according to claim 12, wherein the associating means comprises a plurality of fasteners capable of securing desired edges of the cover to a respective rod of the at least two rods.

16. The protective assembly according to claim 12, wherein the associating means comprises a loop associated with each of the two edges of the cover, wherein a separate rod of the at least two rods is capable of extending through a respective loop.

17. The protective assembly according to claim 12, wherein the associating means comprises a slit extending through each of the at least two rods, each slit capable of releasably retaining at least a portion of one of the plurality of edges of the cover therein.

18. A protective assembly to protect a portion of an outer body of a trailer, comprising:
a housing assembly securable to the outside of a trailer;
at least one cover positionable within the housing assembly, the cover extendable from a retracted position wherein the cover is substantially within the housing assembly to a deployed position wherein the cover extends over an outer body of a trailer; and
at least one fastener capable of securing the at least one cover in a deployed position.

19. The protective assembly according to claim 18, wherein the protective assembly comprises at least two covers, and wherein the housing assembly comprises:
an outer retainer having a plurality of slots extending therethrough, wherein each of the plurality of slots is operably configured for slidable receipt and release of a portion of one of the covers therethrough; and
a divider positionable within the outer retainer, to, in turn, create at least two partitions within the outer retainer for separately retaining the at least two covers therein.

20. The protective assembly according to claim 19, wherein the outer retainer has a first end cap and a second end cap at opposing ends thereof and securable to an outer body of a trailer via the assembly for securing the housing assembly to a trailer.

21. The protective assembly according to claim 20, wherein the first and second end caps of the outer retainer are releasably secured to the outer retainer.
